(19) United States
(12) Patent Application Publication
(10) Pub. No.: US 2025/0385828 A1
(43) Pub. Date: Dec. 18, 2025

(54) AI-BASED ROOT CAUSE ANALYSIS FOR TELECOMMUNICATIONS SYSTEMS

(71) Applicant: MICROSOFT TECHNOLOGY LICENSING, LLC, Redmond, WA (US)

(72) Inventors: Steven Rhejohn Barlin SO, Burlington, MA (US); Philip TO, Lexington, MA (US); Tasneem Khuzema NASEEM, Cambridge, MA (US); Muhammad Umair AFZAL, Abbotsford (CA); Sarim Mohammed AHMED, Burlington, MA (US); Alina ZHENG, Newton, MA (US); Andrew Scott BROOKS, Northborough, MA (US)

(21) Appl. No.: 18/744,581

(22) Filed: Jun. 14, 2024

(51) Int. Cl. H04L 41/0631; H04L 41/16; H04L 43/0823

(52) U.S. Cl. CPC H04L 41/0631; H04L 41/16; H04L 43/0823

(57) ABSTRACT

Conditions are identified in a telecommunications network based on data collected from the telecommunications network. The data comprises time series telemetry data collected from telecommunications systems in the telecommunications network or live production data from the telecommunications network; and raw error logs collected alongside the time series telemetry data for the telecommunications systems. Outputs from a time series insight generator and a sentiment analyzer are combined to generate an output report indicative of anomalous metrics in the telecommunications network.

### BACKGROUND

A cloud network providing mobile communications services such as 5G services can have thousands or millions of nodes such as servers and other devices running various network functions. The nodes and network functions collectively need to operate reliably in order to provide high-performance services. It is therefore important to provide an effective monitoring mechanism to detect issues early, take corrective action, and track nodes and network functions over their lifecycles to maintain network health and avoid downtime. Accurate detection of issues in a complex 5G environment is difficult because of the multi-dimensional aspects of system anomalies that can depend on time as well as relationships between systems, networks, and functions. In a cloud-based system (e.g., one or more data centers) that includes thousands or millions of nodes, the inability to maintain node health and serviceability can have consequences such as processing delays and increased costs, which otherwise can lead to revenue loss and customer dissatisfaction.

It is with respect to these considerations and others that the disclosure made herein is presented.

### SUMMARY

Methods and systems are disclosed for integrating dimensions of time and multiple interdependent system indicators using time-series analysis and textual analysis and using a pretrained model tuned to perform sentiment analysis. This allows for more accurate identification of anomalies, root causes, and corrective actions in 5G environments.

A computing system receives data collected from a telecommunications network. The data comprises time series telemetry data collected from telecommunications systems in the telecommunications network or live production data from the telecommunications network, and raw error logs collected alongside the time series telemetry data for the telecommunications systems. A data parser is used to identify the type of the data and parsing the data into a standardized format. The parsed data is input to a time series insight generator configured to perform quantitative analysis on the parsed data. The parsed data is input to a sentiment analyzer configured to perform qualitative analysis on the parsed data. Outputs from the time series insight generator and the sentiment analyzer are combined to generate an output report indicative of anomalous metrics in the telecommunications network. The output report is usable to identify a condition in the telecommunications network and root causes and recommended actions in response to the identified condition.

This Summary is not intended to limit the scope of the claimed subject matter. Furthermore, the claimed subject matter is not limited to implementations that solve any or all disadvantages noted in any part of this disclosure.

### DESCRIPTION OF DRAWINGS

The Detailed Description is described with reference to the accompanying FIGS. In the FIGS., the left-most digit(s) of a reference number identifies the FIG. in which the reference number first appears. The same reference numbers in different FIGS. indicate similar or identical items.

FIG. 1 is a diagram illustrating the disclosed techniques according to one embodiment disclosed herein.

FIG. 2A is a diagram illustrating an example architecture according to one embodiment disclosed herein.

FIG. 2B is a diagram illustrating an example architecture according to one embodiment disclosed herein.

FIG. 3 is a diagram showing aspects of an example system according to one embodiment disclosed herein.

FIG. 4 is a diagram showing aspects of an example system according to one embodiment disclosed herein.

FIG. 5 is a flow diagram showing aspects of an illustrative routine, according to one embodiment disclosed herein.

FIG. 6 is a computer architecture diagram illustrating aspects of an example computer architecture for a computer capable of executing the software components described herein.

FIG. 7 is a data architecture diagram showing an illustrative example of a computer environment.

### DETAILED DESCRIPTION

A cloud network providing mobile communications services can have thousands or millions of nodes such as servers and other devices running various networking functions. The nodes and networking functions collectively need to operate reliably in order to provide high-performance services. The inability to maintain node health and serviceability can have consequences such as processing delays, increased costs, and frustrated customers.

The present disclosure describes a way to integrate dimensions of time and multiple interdependent system indicators using time-series analysis and textual analysis and using a pretrained model tuned to perform sentiment analysis such as Bidirectional Representation for Transformers (BERT) and Robustly Optimized BERT Pretraining Approach (roBERTa). This allows for more accurate identification of anomalies, root causes, and corrective actions in 5G environments.

Referring to the appended drawings, in which like numerals represent like elements throughout the several FIGURES, aspects of various technologies for generating and using prompts will be described. In the following detailed description, references are made to the accompanying drawings that form a part hereof, and which are shown by way of illustration specific configurations or examples.

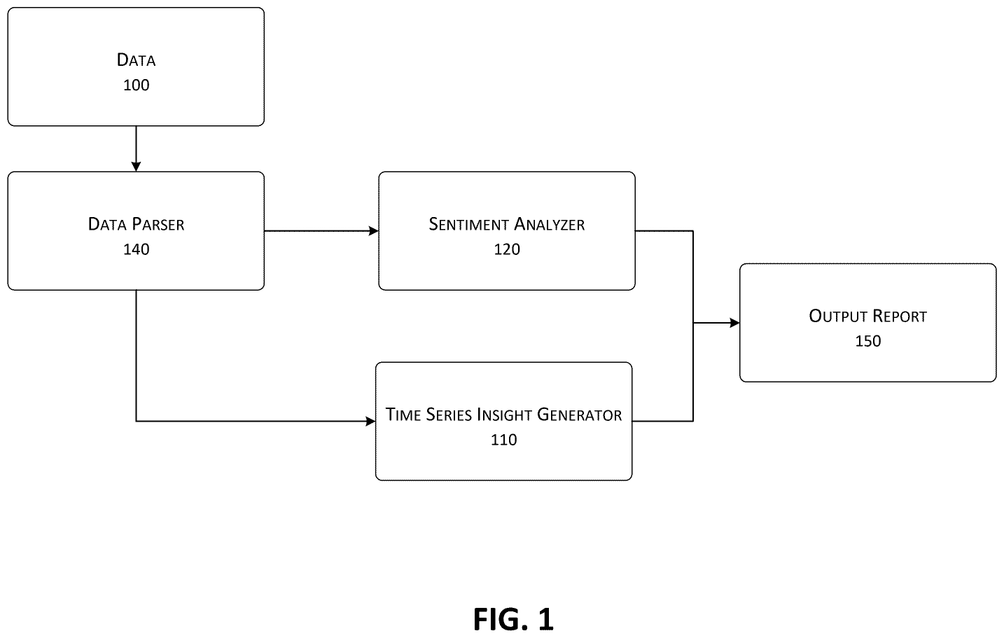

With reference to FIG. 1, illustrated is an example system for identifying conditions in a virtualized computing environment providing a telecommunications network running a plurality of network functions. The conditions can include root causes of issues and problems in the telecommunications network such as outages, problematic latencies, dropped data, and the like. The output of the system can also include recommendations for remediation of the identified conditions. In an embodiment, a computing system receives data 100 collected from the telecommunications network. The data 100 comprises time series telemetry data collected from telecommunications systems in the telecommunications network or live production data from the telecommunications network; and raw error logs collected alongside (e.g., correlated based on time, source, and other factors, or collected from the same source) the time series telemetry data for the telecommunications systems. A data parser 140 is used to identify a type of the data and parsing the data into a standardized format. The parsed data is input to a time series insight generator 110 configured to perform quantitative analysis on the parsed data. The parsed data is input to a sentiment analyzer 120 configured to perform qualitative analysis on the parsed data. Outputs from the time series insight generator and the sentiment analyzer are combined to generate an output report indicative of anomalous metrics in the telecommunications network. The output report 150 is usable to identify a condition in the telecommunications network and root causes and recommended actions in response to the identified condition.

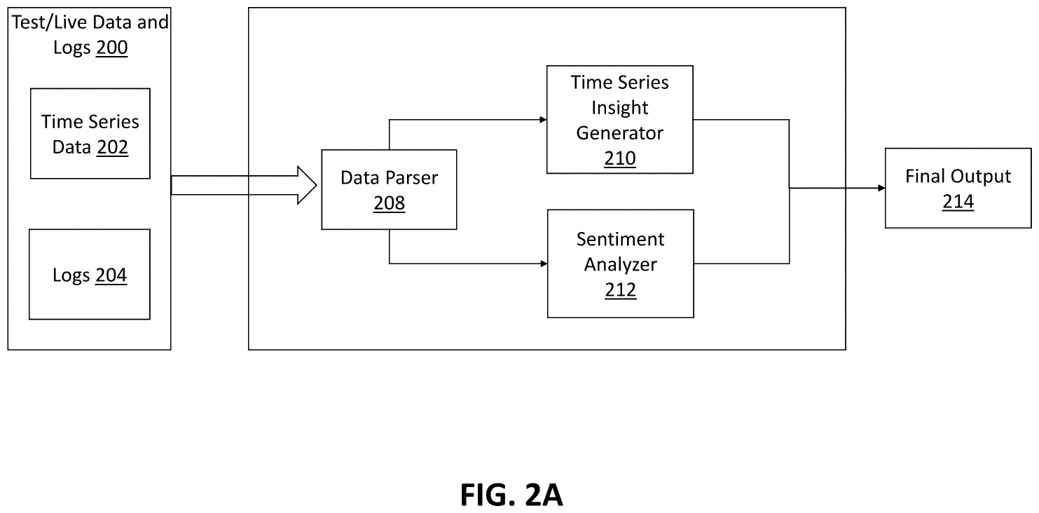

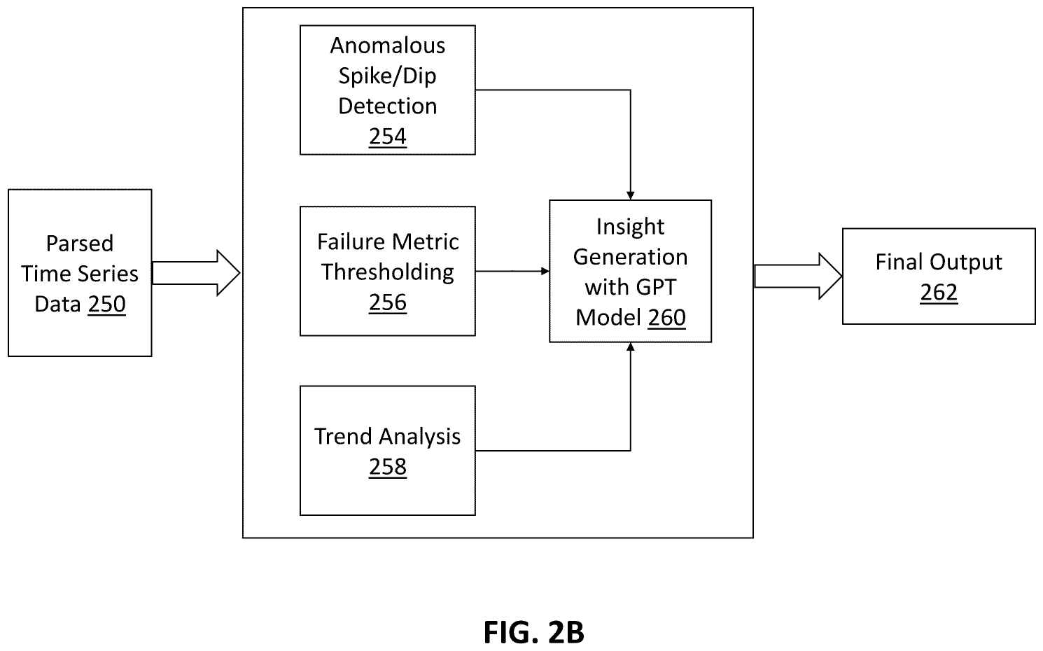

With reference to FIG. 2A, test/live data and logs 200 includes raw data collected from tests run on 4G/5G telecommunications services and products. Such raw data can be collected during development, live production environments, or during post-processing and analysis. Time series data 202 includes telemetry in the form of time series data collected from 4G/5G telecommunications systems. Some examples may include resource information such as memory and CPU usage, or workload related metrics such as session creation attempts, and can be provided in the form of Kargo dumps dump (from an orchestration platform for Kubernetes), MCC performance statistics, etc.

Logs 204 are raw error logs that are collected alongside the time series data 202 for the particular telecommunications product or system being tested. Examples of such logs include tracing system outputs such as Jaegar traces, PCAPs (Packet Captures), log files for containers running in Kubernetes pods (pod logs), and the like. The logs 204 can be correlated in terms of time, locality, and other factors to enable associating or correlating to the time series data 202

Data parser 208 is configured to identify the type of data being passed in and parses the data into a standardized format that can be consumed by the time series insight generator 210 or the sentiment analyzer 212. For example, if the data is a Kargo dump (from an orchestration platform for Kubernetes), the data parser 208 extracts the time series data into comma-separated values (CSVs) or data frames. Similarly, if the data are Jaegar traces, the data parser 208 steps through the log, identifies timestamps or events with English language keywords or descriptions, and creates a data frame mapping timestamps/events to their descriptions in preparation for sentiment analysis.

Time series insight generator 210 is a service that performs quantitative analysis on the parsed time series data. Time series insight generator 210 uses time series analysis techniques to identify anomalies in each metric, such as unusual or anomalous spikes and dips, trends, and number of failures. In an embodiment, time series insight generator 210 generates visual data for the metrics and their anomalies on graphs. LLMs trained on product-specific documentation can extract further insights from these results, including root cause analysis and recommendations of how to resolve the anomalies. Graphical visualizations of the anomalies as well as natural language descriptions, insights, and recommendations are added to the final report 214.

Sentiment analyzer 212 is a service that performs qualitative analysis on the parsed logs. In an embodiment, sentiment analyzer 212 uses a pre-trained sentiment analysis model, such as Bidirectional Representation for Transformers (BERT) and Robustly Optimized BERT Pretraining Approach (roBERTa), to analyze the log and anomalies, i.e., the recorded timestamps/events with the most negative descriptions. In one embodiment, sentiment analyzer 212 provides numerical scores for how negative a sentiment is, with a score of 1 being most negative and a score of 0 being least negative. These scores are used to rank the events from most negative (most anomalous) to least negative (least anomalous). This ranking is used to prioritize the most negative logs.

Additionally, to remove noise from the logs, string similarity algorithms such as sequence matching can be used. String similarity algorithms can be used to identify and discard duplicate detected negative results. Two events are deemed to be similar if they are either completely identical or if they have matching contiguous subsequences. The ranking algorithm can be adjusted based on the results of the similarity algorithm, where a negative event with few duplicates can be considered more anomalous and therefore ranked higher as compared to a negative event with many duplicates. The resulting qualitative anomalies are thus 1) ordered correctly and 2) unique in content.

The qualitative anomalies identified by the sentiment analyzer 212 can also be matched with the quantitative anomalies and insights identified by the time series insight generator 210 for an integrated view of the anomalous metrics in the system and how or why the system may be behaving abnormally.

The sentiment analyzer 212 can be used on the names of the quantitative metrics passed into the time series insight generator 210 to determine which metrics require more sensitive parameter tuning. The number of packet failures, for example, can be identified as a negative metric and thus the condition or threshold to mark this metric as anomalous can be implemented as sensitive. For example, it would be expected to observe low or no packet failures.

The final output 214 combines the results from the time series insight generator 210 and the sentiment analyzer 212. In an embodiment, the final output 214 can be an HTML report that displays graphs for the anomalous metrics with anomalies highlighted. In an embodiment, the metrics are organized by the part of the dump (e.g. the specific directory and file) where the metrics are found in as well as the type of analysis that was performed, such as anomalous spike/dip detection model 254, failure metric thresholding model 256, and trend analysis model 258.

In an embodiment, each anomalous metric graph is accompanied by a natural language description from the insight generation with GPT model 260 that describes the anomalies observed, possible root causes, and recommended actions. In an embodiment, a separate section can be provided that displays the sentiment analysis results, highlighting the anomalous parts of the logs and displaying the results from most to least negative. In an embodiment, the final output 214 can include a natural language summary of all the problems found in the raw data, including the most salient root causes and recommended actions, which are also taken from insight generation with GPT model 260.

With reference to FIG. 2B, parsed time series data 250 is the parsed time series data resulting from a pass through the data parser 208. Anomalous spike/dip detection 254 is a model that uses statistics and time series analysis techniques to identify unusual spikes and dips in the model. Some examples include computations involving sliding windows (in which datapoints are compared against previous points), using thresholds (such as, for example, a factor of the interquartile range) to determine outliers, and fitting overall trends to the data to identify which points differ from the trend by a significant or threshold amount.

With failure metric thresholding 256, for metrics that represent numbers of failures, a model is provided that scales the metrics by computing the percentage of failures (number of failures/number of attempts) and imposes a threshold, whereby a metric that dips above a specified percentage threshold is marked as anomalous. In this way, metrics that have an unusually high percentage of failures can be determined.

For resource usage metrics such as memory and CPU, analyzing the overall trend can allow identification of upward or downward anomalous trends, which can be performed by trend analysis 258. A significant upward trend in memory on a specific federation, for example, can indicate a memory leak. Such a federation-level anomaly can be used to identify the specific pod or container that could be causing an issue.

The trend analysis model 258 can use time series decomposition techniques, such as seasonal decomposition or a Hodrick-Prescott filter to isolate components of the data's behavior over time, including seasonality, cyclicality, and trends. The trend component can be analyzed with techniques such as regression analysis to determine upward or downward slopes over time.

In an embodiment, for a specific metric, the analysis provided by anomalous spike/dip detection 254, failure metric thresholding 256, and trend analysis 258 produces output graphs that plot data for the specific metric over time with anomalies highlighted for each type of analysis. These graphs can be uploaded to a GPT model 260 trained on product-specific documentation. The GPT model 260 can be prompted for additional insight, including possible root causes and recommendations of actions to be taken to resolve the anomaly. These prompts can be further supplemented with the ranked and filtered negative results from the sentiment analyzer 212.

In an embodiment, the GPT model 260 summarizes the anomaly detection results from both the time series insight generator 210 and the sentiment analyzer 212 to produce a single natural language description of the most anomalous results, root causes, and recommendations for possible fixes.

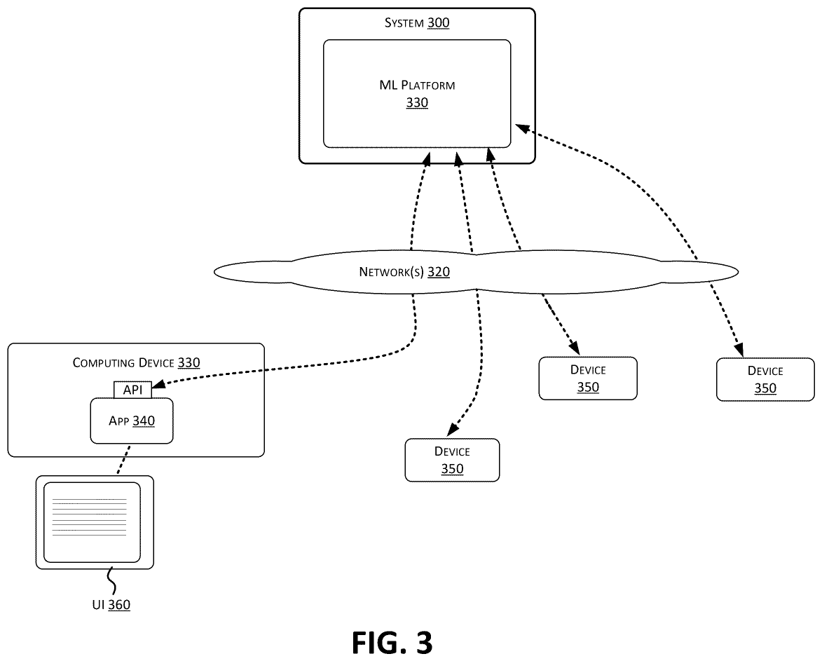

In various embodiments, the machine learning model(s) may be run locally on the client. In other embodiments, the machine learning inferencing can be performed on a server of a network. For example, in the system illustrated in FIG. 3, a system 300 is illustrated that implements ML platform 330. The ML platform 330 may be configured to provide output data to various devices 350 over a network 320, as well as computing device 330. A user interface 360 may be rendered on computing device 330. The user interface 360 may be provided in conjunction with an application 340 that communicates to the ML platform 330 using an API via network 320. In some embodiments, system 300 may be configured to provide issue identification information to users. In one example, ML platform 330 may implement a machine learning system to perform one or more tasks. The ML platform 330 utilizes the machine learning system to perform tasks such as root cause identification. The machine learning system may be configured to be optimized using the techniques described herein.

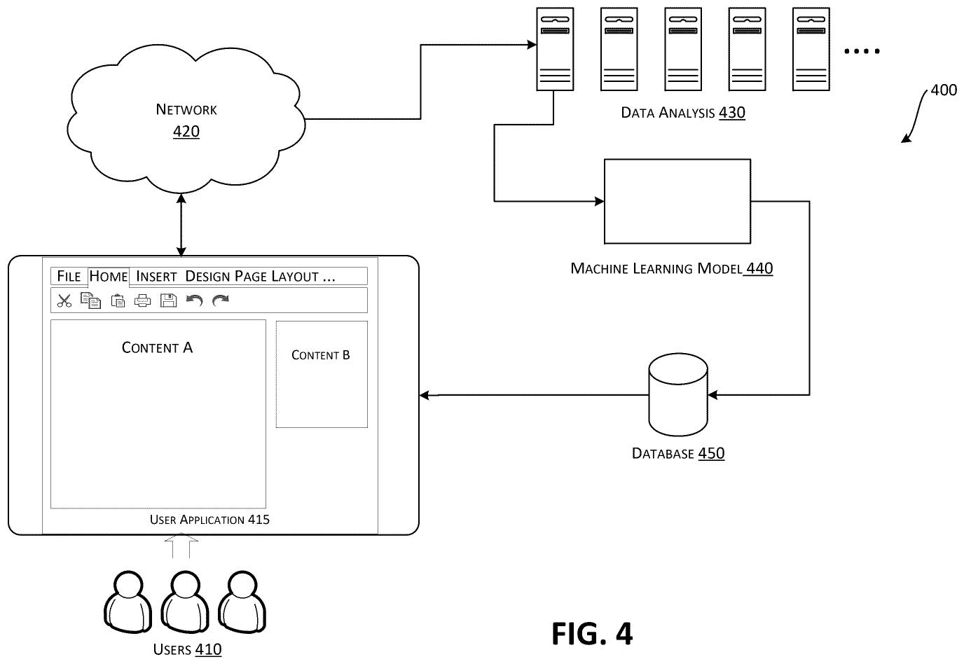

FIG. 4 is a computing system architecture diagram showing an overview of a system disclosed herein for implementing a machine learning model, according to one embodiment disclosed herein. As shown in FIG. 4, a machine learning system 400 may be configured to perform analysis and perform identification, prediction, or other functions based upon various data collected by and processed by data analysis components 430 (which might be referred to individually as an “data analysis component 430” or collectively as the “data analysis components 430”). The data analysis components 430 may, for example, include, but are not limited to, physical computing devices such as server computers or other types of hosts, associated hardware components (e.g., memory and mass storage devices), and networking components (e.g., routers, switches, and cables). The data analysis components 430 can also include software, such as operating systems, applications, and containers, network services, virtual components, such as virtual disks, virtual networks, and virtual machines. Database 450 can include data, such as a database, or a database shard (i.e., a partition of a database). Feedback may be used to further update various parameters that are used by machine learning model 440. Data may be provided to the user application 415 to provide results to various users 410 using a user application 415. In some configurations, machine learning model 440 may be configured to utilize supervised and/or unsupervised machine learning technologies. A model compression framework based on sparsity-inducing regularization optimization as disclosed herein can reduce the amount of data that needs to be processed in such systems and applications. Effective model compression when processing iterations over large amounts of data may provide improved latencies for a number of applications that use such technologies, such as image and sound recognition, recommendation systems, and image analysis.

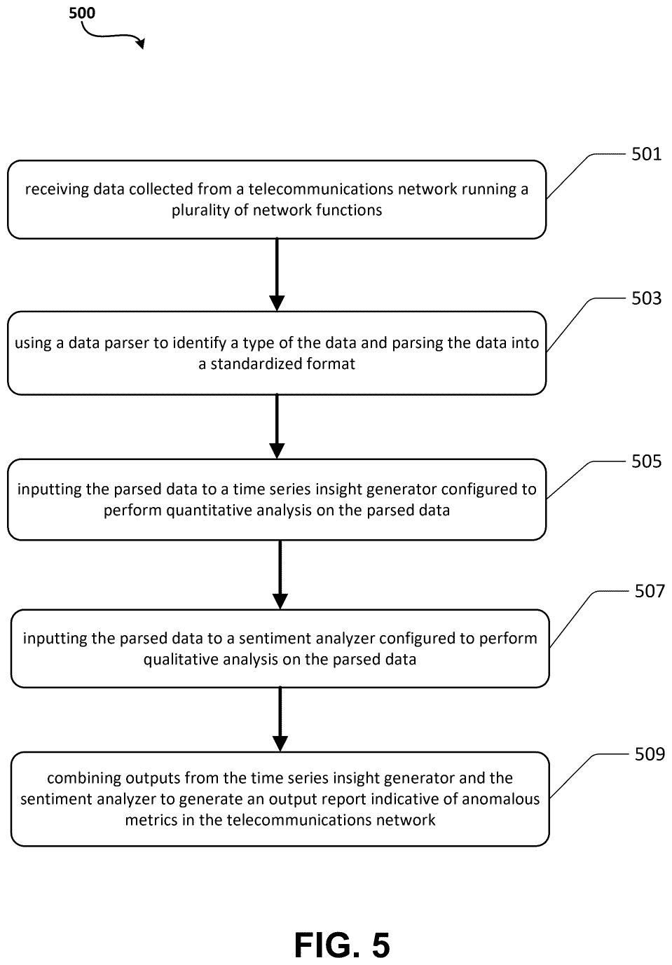

Turning now to FIG. 5, illustrated is an example operational procedure 500 for identifying conditions in a virtualized computing environment providing a telecommunications network running a plurality of network functions in accordance with the present disclosure. The operational procedure may be implemented in a system comprising one or more computing devices.

It should be understood by those of ordinary skill in the art that the operations of the methods disclosed herein are not necessarily presented in any particular order and that performance of some or all of the operations in an alternative order(s) is possible and is contemplated. The operations have been presented in the demonstrated order for ease of description and illustration. Operations may be added, omitted, performed together, and/or performed simultaneously, without departing from the scope of the appended claims.

It should also be understood that the illustrated methods can end at any time and need not be performed in their entireties. Some or all operations of the methods, and/or substantially equivalent operations, can be performed by execution of computer-readable instructions included on a computer-storage media, as defined herein. The term “computer-readable instructions,” and variants thereof, as used in the description and claims, is used expansively herein to include routines, applications, application modules, program modules, programs, components, data structures, algorithms, and the like. Computer-readable instructions can be implemented on various system configurations, including single-processor or multiprocessor systems, minicomputers, mainframe computers, personal computers, hand-held computing devices, microprocessor-based, programmable consumer electronics, combinations thereof, and the like. Although the example routine described below is operating on a computing device, it can be appreciated that this routine can be performed on any computing system which may include a number of computers working in concert to perform the operations disclosed herein.

Thus, it should be appreciated that the logical operations described herein are implemented (1) as a sequence of computer implemented acts or program modules running on a computing system such as those described herein and/or (2) as interconnected machine logic circuits or circuit modules within the computing system. The implementation is a matter of choice dependent on the performance and other requirements of the computing system. Accordingly, the logical operations may be implemented in software, in firmware, in special purpose digital logic, and any combination thereof.

Referring to FIG. 5, operation 501 illustrates receiving, by a computing system, data collected from the telecommunications network. In an embodiment, the data comprises time series telemetry data collected from telecommunications systems in the telecommunications network or live production data from the telecommunications network, and raw error logs for the telecommunications systems. In an embodiment, the raw error logs are associated with the time series telemetry data.

Operation 503 illustrates using a data parser to identify a type of the data and parsing the data into a standardized format.

Operation 505 illustrates inputting the parsed data to a time series insight generator configured to perform quantitative analysis on the parsed data.

Operation 507 illustrates inputting the parsed data to a sentiment analyzer configured to perform qualitative analysis on the parsed data.

Operation 509 illustrates combining outputs from the time series insight generator and the sentiment analyzer to generate an output report indicative of anomalous metrics in the telecommunications network. In an embodiment, the output report is usable to identify a condition in the telecommunications network, root causes of the identified condition, and recommended actions in response to the identified condition. In an embodiment, the output report is usable to initiate an action in the telecommunications network to resolve the identified condition.

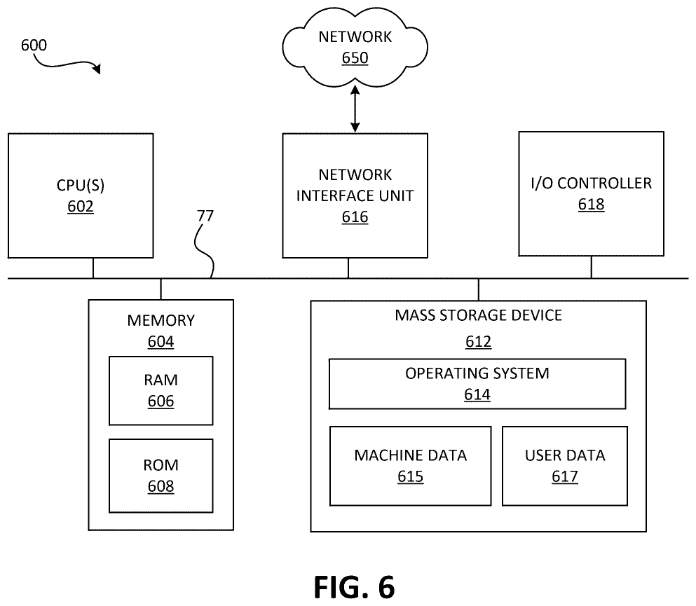

FIG. 6 shows an example computer architecture for a computer capable of providing the functionality described herein such as, for example, a computing device configured to implement the functionality described above with reference to FIGS. 1-6. Thus, the computer architecture 600 illustrated in FIG. 6 illustrates an architecture for a server computer or another type of computing device suitable for implementing the functionality described herein. The computer architecture 600 might be utilized to execute the various software components presented herein to implement the disclosed technologies.

The computer architecture 600 illustrated in FIG. 6 includes a central processing unit 602 (“CPU”), a system memory 604, including a random-access memory 606 (“RAM”) and a read-only memory (“ROM”) 608, and a system bus 77 that couples the memory 604 to the CPU 602. A firmware containing basic routines that help to transfer information between elements within the computer architecture 600, such as during startup, is stored in the ROM 608. The computer architecture 600 further includes a mass storage device 612 for storing an operating system 614, other data, such as product data 615 or user data 617.

The mass storage device 612 is connected to the CPU 602 through a mass storage controller (not shown) connected to the bus 77. The mass storage device 612 and its associated computer-readable media provide non-volatile storage for the computer architecture 600. Although the description of computer-readable media contained herein refers to a mass storage device, such as a solid-state drive, a hard disk or optical drive, it should be appreciated by those skilled in the art that computer-readable media can be any available computer storage media or communication media that can be accessed by the computer architecture 600.

Communication media includes computer readable instructions, data structures, program modules, or other data in a modulated data signal such as a carrier wave or other transport mechanism and includes any delivery media. The term “modulated data signal” means a signal that has one or more of its characteristics changed or set in a manner as to encode information in the signal. By way of example, and not limitation, communication media includes wired media such as a wired network or direct-wired connection, and wireless media such as acoustic, radio frequency, infrared and other wireless media. Combinations of the any of the above should also be included within the scope of computer-readable media.

By way of example, and not limitation, computer-readable storage media might include volatile and non-volatile, removable and non-removable media implemented in any method or technology for storage of information such as computer-readable instructions, data structures, program modules or other data. For example, computer media includes, but is not limited to, RAM, ROM, EPROM, EEPROM, flash memory or other solid state memory technology, CD-ROM, digital versatile disks (“DVD”), HD-DVD, BLU-RAY, or other optical storage, magnetic cassettes, magnetic tape, magnetic disk storage or other magnetic storage devices, or any other medium which can be used to store the desired information and which can be accessed by the computer architecture 600. For purposes of the claims, the phrase “computer storage medium,” “computer-readable storage medium” and variations thereof, does not include waves, signals, and/or other transitory and/or intangible communication media, per se.

According to various implementations, the computer architecture 600 might operate in a networked environment using logical connections to remote computers through a network 650 and/or another network (not shown). A computing device implementing the computer architecture 600 might connect to the network 650 through a network interface unit 616 connected to the bus 77. It should be appreciated that the network interface unit 616 might also be utilized to connect to other types of networks and remote computer systems.

The computer architecture 600 might also include an input/output controller 618 for receiving and processing input from a number of other devices, including a keyboard, mouse, or electronic stylus (not shown in FIG. 6). Similarly, the input/output controller 618 might provide output to a display screen, a printer, or other type of output device (also not shown in FIG. 6).

It should be appreciated that the software components described herein might, when loaded into the CPU 602 and executed, transform the CPU 602 and the overall computer architecture 600 from a general-purpose computing system into a special-purpose computing system customized to facilitate the functionality presented herein. The CPU 602 might be constructed from any number of transistors or other discrete circuit elements, which might individually or collectively assume any number of states. More specifically, the CPU 602 might operate as a finite-state machine, in response to executable instructions contained within the software modules disclosed herein. These computer-executable instructions might transform the CPU 602 by specifying how the CPU 602 transitions between states, thereby transforming the transistors or other discrete hardware elements constituting the CPU 602.

Encoding the software modules presented herein might also transform the physical structure of the computer-readable media presented herein. The specific transformation of physical structure might depend on various factors, in different implementations of this description. Examples of such factors might include, but are not limited to, the technology used to implement the computer-readable media, whether the computer-readable media is characterized as primary or secondary storage, and the like. If the computer-readable media is implemented as semiconductor-based memory, the software disclosed herein might be encoded on the computer-readable media by transforming the physical state of the semiconductor memory. For example, the software might transform the state of transistors, capacitors, or other discrete circuit elements constituting the semiconductor memory. The software might also transform the physical state of such components in order to store data thereupon.

As another example, the computer-readable media disclosed herein might be implemented using magnetic or optical technology. In such implementations, the software presented herein might transform the physical state of magnetic or optical media, when the software is encoded therein. These transformations might include altering the magnetic characteristics of locations within given magnetic media. These transformations might also include altering the physical features or characteristics of locations within given optical media, to change the optical characteristics of those locations. Other transformations of physical media are possible without departing from the scope and spirit of the present description, with the foregoing examples provided only to facilitate this discussion.

In light of the above, it should be appreciated that many types of physical transformations take place in the computer architecture 600 in order to store and execute the software components presented herein. It also should be appreciated that the computer architecture 600 might include other types of computing devices, including hand-held computers, embedded computer systems, personal digital assistants, and other types of computing devices known to those skilled in the art.

It is also contemplated that the computer architecture 600 might not include all of the components shown in FIG. 6, might include other components that are not explicitly shown in FIG. 6, or might utilize an architecture completely different than that shown in FIG. 6. For example, and without limitation, the technologies disclosed herein can be utilized with multiple CPUS for improved performance through parallelization, graphics processing units (“GPUs”) for faster computation, and/or tensor processing units (“TPUs”). The term “processor” as used herein encompasses CPUs, GPUs, TPUs, and other types of processors.

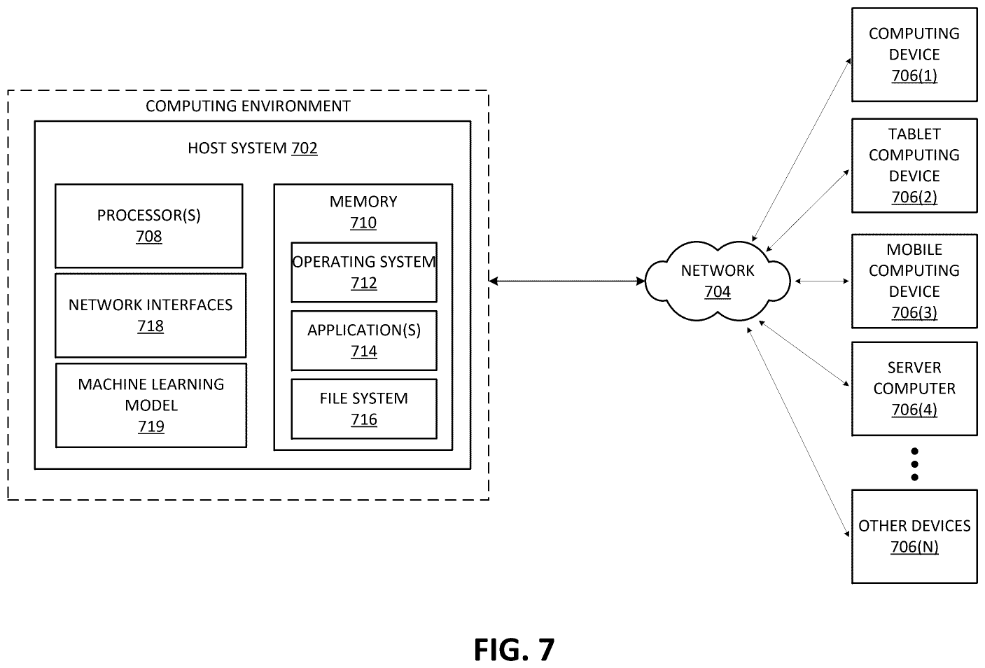

FIG. 7 illustrates an example computing environment capable of executing the techniques and processes described above with respect to FIGS. 1-6. In various examples, the computing environment comprises a host system 702. In various examples, the host system 702 operates on, in communication with, or as part of a network 704.

The network 704 can be or can include various access networks. For example, one or more client devices 706(1) . . . 706(N) can communicate with the host system 702 via the network 704 and/or other connections. The host system 702 and/or client devices can include, but are not limited to, any one of a variety of devices, including portable devices or stationary devices such as a server computer, a smart phone, a mobile phone, a personal digital assistant (PDA), an electronic book device, a laptop computer, a desktop computer, a tablet computer, a portable computer, a gaming console, a personal media player device, or any other electronic device.

According to various implementations, the functionality of the host system 702 can be provided by one or more servers that are executing as part of, or in communication with, the network 704. A server can host various services, virtual machines, portals, and/or other resources. For example, a can host or provide access to one or more portals, Web sites, and/or other information.

The host system 702 can include processor(s) 708 memory 710. The memory 710 can comprise an operating system 712, application(s) 714, and/or a file system 716. Moreover, the memory 710 can comprise the storage unit(s) 82 described above with respect to FIGS. 1-5.

The processor(s) 708 can be a single processing unit or a number of units, each of which could include multiple different processing units. The processor(s) can include a microprocessor, a microcomputer, a microcontroller, a digital signal processor, a central processing unit (CPU), a graphics processing unit (GPU), a security processor etc. Alternatively, or in addition, some or all of the techniques described herein can be performed, at least in part, by one or more hardware logic components. For example, and without limitation, illustrative types of hardware logic components that can be used include a Field-Programmable Gate Array (FPGA), an Application-Specific Integrated Circuit (ASIC), an Application-Specific Standard Products (ASSP), a state machine, a Complex Programmable Logic Device (CPLD), other logic circuitry, a system on chip (SoC), and/or any other devices that perform operations based on instructions. Among other capabilities, the processor(s) may be configured to fetch and execute computer-readable instructions stored in the memory 710.

The memory 710 can include one or a combination of computer-readable media. As used herein, “computer-readable media” includes computer storage media and communication media.

Computer storage media includes volatile and non-volatile, removable and non-removable media implemented in any method or technology for storage of information, such as computer-readable instructions, data structures, program modules, or other data. Computer storage media includes, but is not limited to, phase change memory (PCM), static random-access memory (SRAM), dynamic random-access memory (DRAM), other types of random-access memory (RAM), read-only memory (ROM), electrically erasable programmable ROM (EEPROM), flash memory or other memory technology, compact disk ROM (CD-ROM), digital versatile disks (DVD) or other optical storage, magnetic cassettes, magnetic tape, magnetic disk storage or other magnetic storage devices, or any other medium that can be used to store information for access by a computing device.

In contrast, communication media includes computer-readable instructions, data structures, program modules, or other data in a modulated data signal, such as a carrier wave. As defined herein, computer storage media does not include communication media.

The host system 702 can communicate over the network 704 via network interfaces 718. The network interfaces 718 can include various types of network hardware and software for supporting communications between two or more devices. The host system 702 may also include machine learning model 719.

In closing, although the various techniques have been described in language specific to structural features and/or methodological acts, it is to be understood that the subject matter defined in the appended representations is not necessarily limited to the specific features or acts described. Rather, the specific features and acts are disclosed as example forms of implementing the claimed subject matter.

The disclosure presented herein also encompasses the subject matter set forth in the following clauses:

Clause 1: A method of identifying conditions in a virtualized computing environment providing a telecommunications network running a plurality of network functions, the method comprising:
receiving, by a computing system, data collected from the telecommunications network, wherein the data comprises:
   time series telemetry data collected from telecommunications systems in the telecommunications network or live production data from the telecommunications network; and
   raw error logs for the telecommunications systems, the raw error logs associated with the time series telemetry data;
using a data parser to identify a type of the data and parsing the data into a standardized format;
inputting the parsed data to a time series insight generator configured to perform quantitative analysis on the parsed data;
inputting the parsed data to a sentiment analyzer configured to perform qualitative analysis on the parsed data; and
combining outputs from the time series insight generator and the sentiment analyzer to generate an output report indicative of anomalous metrics in the telecommunications network; wherein the output report is usable to identify a condition in the telecommunications network, root causes of the identified condition, and recommended actions in response to the identified condition; wherein the output report is usable to initiate an action in the telecommunications network to resolve the identified condition.

Clause 2: The method of clause 1, wherein the sentiment analyzer comprises a pre-trained sentiment analysis model.

Clause 3: The method of any of clauses 1-2, wherein the sentiment analyzer is configured to generate numerical scores indicative of a negative sentiment indicative of an anomaly.

Clause 4: The method of any of clauses 1-3, further comprising using a string similarity algorithm to identify duplicate detected negative results.

Clause 5: The method of any of clauses 1-4, further comprising matching qualitative anomalies identified by the sentiment analyzer with quantitative anomalies and insights identified by the time series insight generator.

Clause 6: The method of any of clauses 1-5, further comprising using an anomalous spike/dip detection model to identify spikes and dips in the data.

Clause 7: The method of clauses 1-6, further comprising using a failure metric thresholding model to scale metrics by computing a percentage of failure, wherein a metric that exceeds a specified percentage threshold is identified as anomalous.

Clause 8: The method of any of clauses 1-7, further comprising using a trend analysis model to identify upward or downward anomalous trends in the data.

Clause 9: A computing system, comprising:
one or more processors; and
a computer-readable storage medium having computer-executable instructions stored thereupon which, when executed by the processor, cause the computing system to perform operations comprising:
receiving data collected from a telecommunications network running a plurality of network functions, wherein the data comprises:
   time series telemetry data collected from telecommunications systems in the telecommunications network or live production data from the telecommunications network; and
   raw error logs collected in conjunction with the time series telemetry data for the telecommunications systems;
using a data parser to identify a type of the data parsing the data into a standardized format;
inputting the parsed data to a time series insight generator configured to perform quantitative analysis on the parsed data;
inputting the parsed data to a sentiment analyzer configured to perform qualitative analysis on the parsed data; and
combining outputs from the time series insight generator and the sentiment analyzer to generate an output report indicative of anomalous metrics in the telecommunications network; wherein the output report is usable to identify a condition in the telecommunications network, root causes of the identified condition, and recommended actions in response to the identified condition.

Clause 10: The computing system of clause 9, wherein the sentiment analyzer uses a pre-trained sentiment analysis model.

Clause 11: The computing system of any of clauses 9 and 10, wherein the sentiment analyzer is configured to generate numerical scores indicative of a negative sentiment indicative of an anomaly.

Clause 12: The computing system of any of clauses 9-11, further comprising computer-executable instructions stored thereupon which, when executed by the processor, cause the computing system to perform operations comprising using a string similarity algorithm to identify duplicate detected negative results.

Clause 13: The computing system of any of clauses 9-12, further comprising computer-executable instructions stored thereupon which, when executed by the processor, cause the computing system to perform operations comprising matching qualitative anomalies identified by the sentiment analyzer with quantitative anomalies and insights identified by the time series insight generator.

Clause 14: The computing system of any of clauses 9-13, further comprising computer-executable instructions stored thereupon which, when executed by the processor, cause the computing system to perform operations comprising using an anomalous spike/dip detection model to identify spikes and dips in the data.

Clause 15: The computing system of any of clauses 9-14, further comprising computer-executable instructions stored thereupon which, when executed by the processor, cause the computing system to perform operations comprising using a failure metric thresholding model to scale metrics by computing a percentage of failure, wherein a metric that exceeds a specified percentage threshold is identified as anomalous.

Clause 16: The computing system of any of clauses 9-15, further comprising computer-executable instructions stored thereupon which, when executed by the processor, cause the computing system to perform operations comprising using a trend analysis model to identify upward or downward anomalous trends in the data.

Clause 17: A computer-readable storage medium having computer-executable instructions stored thereupon which, when executed by a processor of a computing system, cause the computing system to perform operations comprising:
receiving data collected from a telecommunications network running a plurality of network functions, wherein the data comprises:
   time series telemetry data collected from telecommunications systems in the telecommunications network or live production data from the telecommunications network; and
   raw error logs collected with the time series telemetry data for the telecommunications systems;
using a data parser to identify a type of the data parsing the data into a standardized format;
inputting the parsed data to a time series insight generator configured to perform quantitative analysis on the parsed data;
inputting the parsed data to a sentiment analyzer configured to perform qualitative analysis on the parsed data; and
combining outputs from the time series insight generator and the sentiment analyzer to generate an output report indicative of anomalous metrics in the telecommunications network; wherein the output report is usable to identify a condition in the telecommunications network and root causes and recommended actions in response to the identified condition.

Clause 18: The computer-readable storage medium of clause 17, further comprising computer-executable instructions stored thereupon which, when executed by a processor of a computing system, cause the computing system to perform operations comprising using a string similarity algorithm to identify duplicate detected negative results.

Clause 19: The computer-readable storage medium of any of clauses 17 and 18, further comprising computer-executable instructions stored thereupon which, when executed by a processor of a computing system, cause the computing system to perform operations comprising matching qualitative anomalies identified by the sentiment analyzer with quantitative anomalies and insights identified by the time series insight generator.

Clause 20: The computer-readable storage medium of any of the clauses 17-19, further comprising computer-executable instructions stored thereupon which, when executed by a processor of a computing system, cause the computing system to perform operations comprising using an anomalous spike/dip detection model to identify spikes and dips in the data.

What is claimed is:

1. A method of identifying conditions in a virtualized computing environment providing a telecommunications network running a plurality of network functions, the method comprising:
receiving, by a computing system, data collected from the telecommunications network, wherein the data comprises:
time series telemetry data collected from telecommunications systems in the telecommunications network or live production data from the telecommunications network; and
raw error logs for the telecommunications systems, the raw error logs associated with the time series telemetry data;
using a data parser to identify a type of the data and parsing the data into a standardized format;
inputting the parsed data to a time series insight generator configured to perform quantitative analysis on the parsed data;
inputting the parsed data to a sentiment analyzer configured to perform qualitative analysis on the parsed data; and
combining outputs from the time series insight generator and the sentiment analyzer to generate an output report indicative of anomalous metrics in the telecommunications network; wherein the output report is usable to identify a condition in the telecommunications network, root causes of the identified condition, and recommended actions in response to the identified condition; wherein the output report is usable to initiate an action in the telecommunications network to resolve the identified condition.

2. The method of claim 1, wherein the sentiment analyzer comprises a pre-trained sentiment analysis model.

3. The method of claim 1, wherein the sentiment analyzer is configured to generate numerical scores indicative of a negative sentiment indicative of an anomaly.

4. The method of claim 1, further comprising using a string similarity algorithm to identify duplicate detected negative results.

5. The method of claim 1, further comprising matching qualitative anomalies identified by the sentiment analyzer with quantitative anomalies and insights identified by the time series insight generator.

6. The method of claim 1, further comprising using an anomalous spike/dip detection model to identify spikes and dips in the data.

7. The method of claim 1, further comprising using a failure metric thresholding model to scale metrics by computing a percentage of failure, wherein a metric that exceeds a specified percentage threshold is identified as anomalous.

8. The method of claim 1, further comprising using a trend analysis model to identify upward or downward anomalous trends in the data.

9. A computing system, comprising:
one or more processors; and
a computer-readable storage medium having computer-executable instructions stored thereupon which, when executed by the processor, cause the computing system to perform operations comprising:
receiving data collected from a telecommunications network running a plurality of network functions, wherein the data comprises:
time series telemetry data collected from telecommunications systems in the telecommunications network or live production data from the telecommunications network; and
raw error logs collected in conjunction with the time series telemetry data for the telecommunications systems;
using a data parser to identify a type of the data parsing the data into a standardized format;
inputting the parsed data to a time series insight generator configured to perform quantitative analysis on the parsed data;
inputting the parsed data to a sentiment analyzer configured to perform qualitative analysis on the parsed data; and
combining outputs from the time series insight generator and the sentiment analyzer to generate an output report indicative of anomalous metrics in the telecommunications network; wherein the output report is usable to identify a condition in the telecommunications network, root causes of the identified condition, and recommended actions in response to the identified condition.

10. The computing system of claim 9, wherein the sentiment analyzer uses a pre-trained sentiment analysis model.

11. The computing system of claim 9, wherein the sentiment analyzer is configured to generate numerical scores indicative of a negative sentiment indicative of an anomaly.

12. The computing system of claim 9, further comprising computer-executable instructions stored thereupon which, when executed by the processor, cause the computing system to perform operations comprising using a string similarity algorithm to identify duplicate detected negative results.

13. The computing system of claim 9, further comprising computer-executable instructions stored thereupon which, when executed by the processor, cause the computing system to perform operations comprising matching qualitative anomalies identified by the sentiment analyzer with quantitative anomalies and insights identified by the time series insight generator.

14. The computing system of claim 9, further comprising computer-executable instructions stored thereupon which, when executed by the processor, cause the computing system to perform operations comprising using an anomalous spike/dip detection model to identify spikes and dips in the data.

15. The computing system of claim 9, further comprising computer-executable instructions stored thereupon which, when executed by the processor, cause the computing system to perform operations comprising using a failure metric thresholding model to scale metrics by computing a percentage of failure, wherein a metric that exceeds a specified percentage threshold is identified as anomalous.

16. The computing system of claim 9, further comprising computer-executable instructions stored thereupon which, when executed by the processor, cause the computing system to perform operations comprising using a trend analysis model to identify upward or downward anomalous trends in the data.

17. A computer-readable storage medium having computer-executable instructions stored thereupon which, when executed by a processor of a computing system, cause the computing system to perform operations comprising:
receiving data collected from a telecommunications network running a plurality of network functions, wherein the data comprises:
time series telemetry data collected from telecommunications systems in the telecommunications network or live production data from the telecommunications network; and
raw error logs collected with the time series telemetry data for the telecommunications systems;
using a data parser to identify a type of the data parsing the data into a standardized format;
inputting the parsed data to a time series insight generator configured to perform quantitative analysis on the parsed data;
inputting the parsed data to a sentiment analyzer configured to perform qualitative analysis on the parsed data; and
combining outputs from the time series insight generator and the sentiment analyzer to generate an output report indicative of anomalous metrics in the telecommunications network; wherein the output report is usable to identify a condition in the telecommunications network and root causes and recommended actions in response to the identified condition.

18. The computer-readable storage medium of claim 17, further comprising computer-executable instructions stored thereupon which, when executed by a processor of a computing system, cause the computing system to perform operations comprising using a string similarity algorithm to identify duplicate detected negative results.

19. The computer-readable storage medium of claim 18, further comprising computer-executable instructions stored thereupon which, when executed by a processor of a computing system, cause the computing system to perform operations comprising matching qualitative anomalies identified by the sentiment analyzer with quantitative anomalies and insights identified by the time series insight generator.

20. The computer-readable storage medium of claim 19, further comprising computer-executable instructions stored thereupon which, when executed by a processor of a computing system, cause the computing system to perform operations comprising using an anomalous spike/dip detection model to identify spikes and dips in the data.
